(19) United States
(12) Patent Application Publication
(10) Pub. No.: US 2014/0337245 A1
(43) Pub. Date: Nov. 13, 2014

(54) GENERATION OF SHIPMENT TRACKING REPORT USING TEXT ANALYTICS

(71) Applicant: INTERNATIONAL BUSINESS MACHINES CORPORATION, Armonk, NY (US)

(72) Inventors: Dhruv A. Bhatt, Indian Trail, NC (US); Kristin E. McNeil, Charlotte, NC (US); Nitaben A. Patel, Charlotte, NC (US)

(73) Assignee: International Business Machines Corporation, Armonk, NY (US)

(21) Appl. No.: 13/891,275

(22) Filed: May 10, 2013

(51) Int. Cl. G06Q 10/08

(52) U.S. Cl. CPC G06Q 10/0833
USPC 705/333

(57) ABSTRACT

In a method for compiling shipping information, one or more emails are received. A processor analyzes the one or more emails to determine tracking information and initial shipping information for one or more shipments. A processor determines current shipping information for each of the one or more shipments using the tracking information for each respective shipment.

### FIELD OF THE INVENTION

The present invention relates generally to the field of delivery tracking software and more specifically to gathering shipping information using tracking information extracted from emails.

### BACKGROUND OF THE INVENTION

Catalogue, internet, phone and other shopping methods oftentimes involve one or more deliveries of purchased goods to customer specified locations by either the merchant or a shipment service company. Many merchants and shipment service companies provide customers with a tracking number, link, and/or login account information to track their shipments. Oftentimes, this information is provided to a customer by email.

Using received tracking information, a customer may be able to log onto a merchant or shipment service company website, or access a computer application, that gives detailed information about the status of the shipment. Shipment status information may include package weight, service type, estimated delivery date, package details, current location, current status, or other relevant information.

An email application client may allow a user to compose, send, receive, store, and otherwise manage emails from one or more email accounts. Typically, an email application client stores received (and oftentimes sent) email until a user deletes the email.

### SUMMARY

Aspects of an embodiment of the present invention disclose a method, computer program product, and computing system for compiling shipping information. One or more emails are received. A processor analyzes the one or more emails to determine tracking information and initial shipping information for one or more shipments. A processor determines current shipping information for each of the one or more shipments using the tracking information for each respective shipment.

### BRIEF DESCRIPTION OF THE SEVERAL VIEWS OF THE DRAWINGS

FIG. 1 depicts a diagram of a computing system in accordance with one embodiment of the present invention.

FIG. 2 depicts a flowchart of the steps of a shipment tracking server program executing within the computing system of FIG. 1, for extracting initial shipping information from one or more emails, using tracking information to obtain current shipping information, and generating a shipment tracking report using all gathered shipping information.

FIG. 3 is an exemplary user interface to a shipment tracking client program in accordance with one embodiment of the present invention.

FIG. 4 is an exemplary shipment tracking report window displayed by a shipment tracking client program, in accordance with one embodiment of the present invention.

FIG. 5 depicts a block diagram of components of the shipping company server, the client computing device, and the server computing device of FIG. 1 in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures.

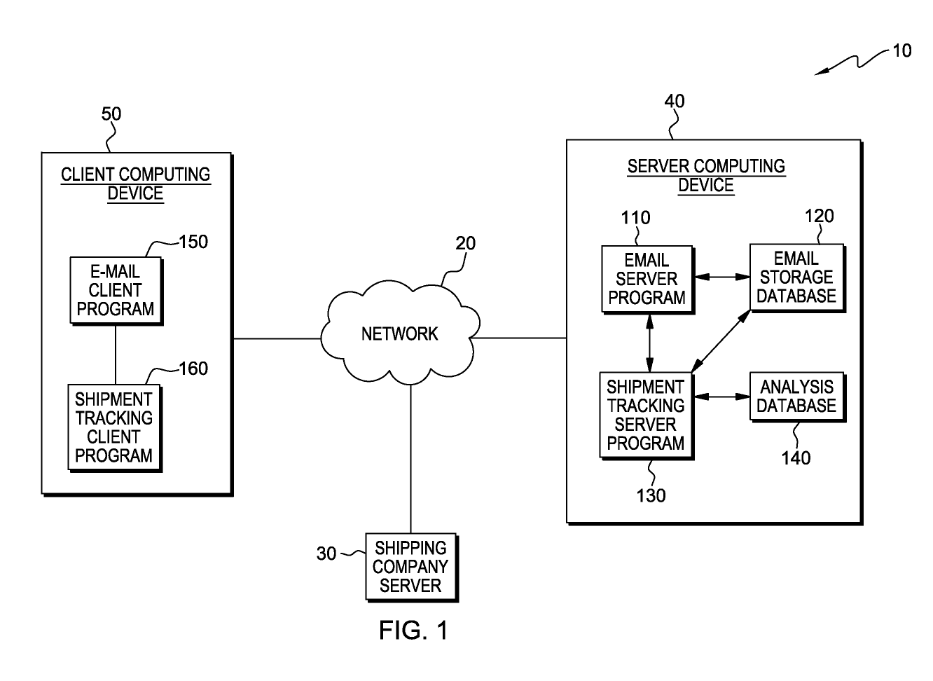

FIG. 1 depicts a diagram of computing system 10 in accordance with one embodiment of the present invention. FIG. 1 provides only an illustration of one embodiment and does not imply any limitations with regard to the environments in which different embodiments may be implemented.

In the depicted embodiment, computing system 10 includes shipping company server 30, server computing device 40, and client computing device 50 interconnected over network 20. Network 20 may be a local area network (LAN), a wide area network (WAN) such as the Internet, the public switched telephone network (PSTN), any combination thereof, or any combination of connections and protocols that will support communications between shipping company server 30, server computing device 40, and client computing device 50 in accordance with embodiments of the invention. Network 20 may include wired, wireless, or fiber optic connections. Computing system 10 may include additional computing devices, servers, computers, or other devices not shown.

Shipping company server 30 may be a management server, a web server, or any other electronic device capable of receiving and sending data. In another embodiment, shipping company server 30 may represent a server computing system utilizing multiple computers as a server system, such as in a cloud computing environment. Shipping company server 30 may be associated with any merchant, shipment service company, or mail service capable of providing current shipping information to customers. In one embodiment, current shipping information is shipping information obtained from a shipping company server, such as shipping company server 30, and may be current as of when shipment tracking server program 130 sends for the request.

In one embodiment, shipping company server 30 may be a server for a shipment service company that provides customers with tracking information, such as a tracking number or link, to track packages from purchase to delivery. Customers may be able to use the tracking number or link to connect to a tracking website or application hosted on shipping company server 30. Once connected to the tracking site, a customer may be able to view current shipping information. Current shipping information might include package weight, estimated delivery date, package location, transit status, or other shipping information.

Server computing device 40 may be a management server, a web server, or any other electronic device or computing system capable of receiving and sending data. In other embodiments, server computing device 40 may represent a server computing system utilizing multiple computers as a server system, such as in a cloud computing environment. Server computing device 40 contains email server program 110, email storage database 120, shipment tracking server program 130, and analysis database 140.

Client computing device 50 may be a desktop computer, laptop computer, tablet computer, personal digital assistant, or smart phone. In general, client computing device 50 may be any electronic device or computing system capable of sending and receiving data, and communicating with server computing device 40 over network 20. Client computing device 50 contains email client program 150 and shipment tracking client program 160.

Email client program 150 may be a dedicated client email program, a function integrated within other programs, a web browser, or any other program or function that can communicate with email server program 110 and provide a user interface for viewing, creating, storing, or otherwise managing emails for at least one email account.

Shipment tracking client program 160 may be a dedicated shipment tracking client program, a function of a client email program, such as email client program 150, a web browser, or any other program or function that can communicate with shipment tracking server program 130 and provide a user interface for requesting that shipment tracking server program 130 create a shipment tracking report.

Email server program 110 operates to receive, forward, store, and manage email messaging services from client computing device 50 and other client computing devices (not shown). In one embodiment, email server program 110 stores email messages to email storage database 120. In one embodiment, email server program 110 resides on server computing device 40. In other embodiments, email server program 110 may reside on another server or another computing device, provided that email server program 110 is accessible to email client program 150 and email server program 110 has access to email storage database 120.

Email storage database 120 may be a repository that may be written and read by email server program 110 and may be accessible to shipment tracking server program 130. Email storage database 120 may be a database or file.

Shipment tracking server program 130 operates to extract initial shipping information from emails in at least one email account, use the extracted initial shipping information to connect to at least one shipping company server, such as shipping company server 30, obtain current shipping information from the at least one shipping company server, and use all of the shipping information obtained to generate a shipment tracking report. In one embodiment, initial shipping information is shipping information obtained from emails in the at least one email account. In one embodiment, shipment tracking server program 130 may parse through one or more emails and gather initial shipping information for one or more shipments. In addition, shipment tracking server program 130 may gather current shipping information from many different merchants and shipment service companies.

In one embodiment, shipment tracking server program 130 resides on server computing device 40. In other embodiments, shipment tracking server program 130 may reside on another server or another computing device, provided that shipment tracking server program 130 is accessible to shipment tracking client program 160 and has access to email storage database 120, analysis database 140, and shipping company server 30. Shipment tracking server program 130 may be a standalone program or it may be a function integrated within an email server program such as email server program 110.

In one embodiment, shipment tracking server program 130 uses natural language processing and at least one set of dictionaries and rules to perform text analytics on individual emails in an email account to determine if each individual email contains initial shipping information. Text analytics can be performed using an Unstructured Information Management Architecture (UIMA) application configured to analyze unstructured information to discover knowledge that is relevant to shipment tracking server program 130, by processing plain text and identifying entities, such as persons, places, organizations; or relations, such as shipping-to or located-at.

Analysis database 140 may be a repository that may be written to and read by shipment tracking server program 130. The contents of analysis database 140 include annotators which consist of rules and dictionaries. Shipment tracking server program 130 can maintain an analysis structure in analysis database 140, which provides the annotators with a facility for efficiently building and searching the analysis structure. The analysis structure is a data structure that is mainly composed of meta-data descriptive of sub-sequences of the text of the emails received from email storage database 120. An exemplary type of meta-data in an analysis structure is an annotation. An annotation is an object, with its own properties, that is used to annotate a sequence of text. There are an arbitrary number of types of annotations. For example, annotations may label sequences of text in terms of their role in the email's structure (e.g., word, sentence, paragraph, etc.), or to describe them in terms of their grammatical role (e.g., noun, noun phrase, verb, adjective, etc.). Annotations may further determine the domain of an email (e.g., advertisement, personal, shipment confirmation, etc.). Further still, annotators may identify sequences of text indicating estimated shipping dates, tracking numbers, links to tracking websites, couriers, or other shipping information. There is essentially no limit on the number of, or application of, annotations. Other examples include annotating segments of text to identify them as proper names, locations, times, events, dates, descriptions, weights, or other items of significance or interest. Annotating the email can further include determining the merchant or shipment service company that is performing the delivery, as a prelude to narrowing a range of further applicable annotators, that may be company specific, or in order to select domain specific rules and dictionaries.

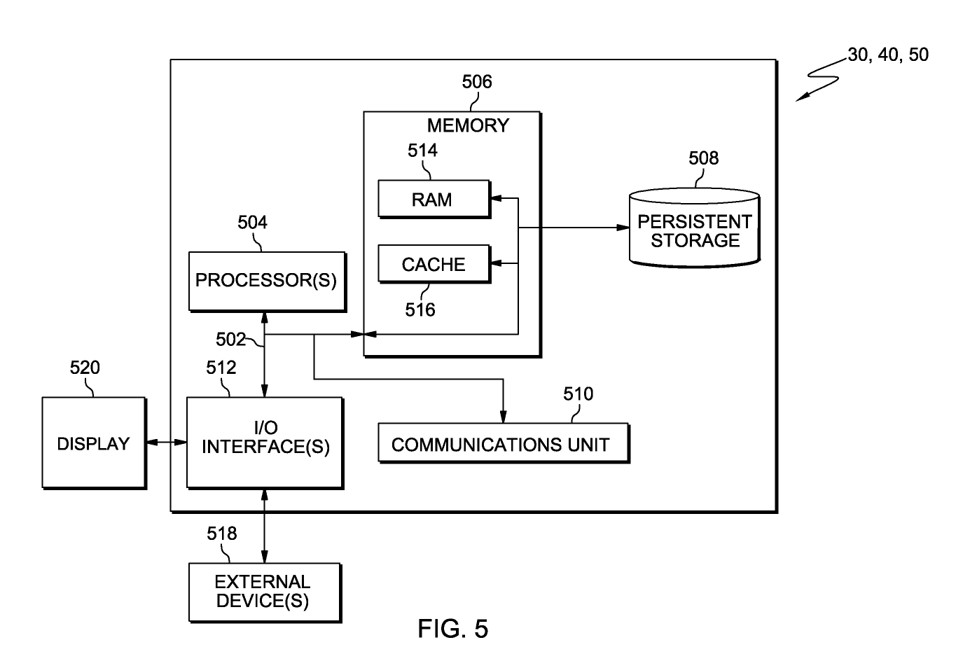

Shipping company server 30, server computing device 40, and client computing device 50 may each include components as depicted in further detail with respect to FIG. 5.

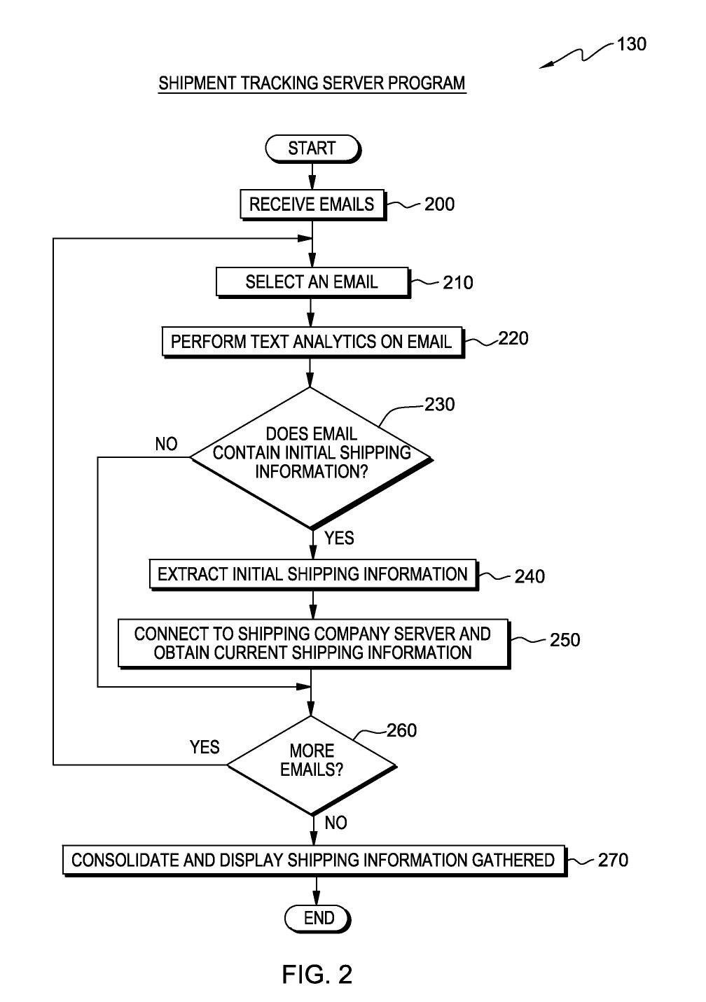

FIG. 2 depicts a flowchart of the steps of shipment tracking server program 130 executing within the computing system of FIG. 1, for extracting initial shipping information from one or more emails, using tracking information to obtain current shipping information, and generating a shipment tracking report using all gathered shipping information, in accordance with one embodiment of the present invention.

In one embodiment, initially, a user may purchase items from various merchants through online shopping, catalogues, telephone, or mailing services. For example, a user might purchase an item online using client computing device 50. A user may also expect a delivery for another reason, such as when a gift is sent to the user from a friend or relative. It is common practice in the industry for a merchant or shipment service company to provide a user expecting a delivery with initial shipping information, and oftentimes the provided initial shipping information will include tracking information. Typically, tracking information may take the form of a tracking number or direct link to a tracking webpage. Oftentimes, tracking information will be delivered to a user via an email message from the merchant or shipment service company involved in the transaction. In addition, the received email may contain initial shipping information about the delivery such as package weight, estimated delivery date, current location, previous locations, and/or other related information. Once received, a user can use the tracking information to connect to a shipping company database or server through a tracking website, or other similar webpage or application. This tracking website, or other application, will provide the user with current shipping information such as package weight, estimated delivery date, current location, previous locations, and other related information.

A user may purchase multiple items from different merchants and may be expecting deliveries from multiple shipment service companies. A user may have several emails containing tracking information for each item. A user may initiate shipment tracking server program 130 through shipment tracking client program 160 by inputting at least one email address along with other necessary information to allow shipment tracking server program 130 to gain access to the desired email account(s).

Information required to gain access to an email account may include the email address, account password, account type (e.g., POP3, IMAP, etc.), incoming mail server and outgoing mail server (SMTP) information. Some embodiments of the present invention may be integrated into an email client program, such as email client program 150, and may not require additional information to access the email account.

Once shipment tracking server program 130 has the necessary information required to access the email account(s), in step 200, shipment tracking server program 130 receives one or more emails from email storage database 120. In one embodiment, shipment tracking server 130 accesses email storage database 120 and retrieves the one or more emails. In another embodiment, shipment tracking server program 130 may request the one or more emails from email server program 110. The emails may include all emails in the email account, not necessarily only emails containing initial shipping information. In some embodiments, the emails received by shipment tracking server program 130 may be restricted to email messages received in the email account inbox during time periods selected by a user at client computing device 50 through a user interface of shipment tracking client program 160.

In step 210, shipment tracking server program 130 selects an email to analyze. Embodiments of shipment tracking server program 130 may select emails to be analyzed by date, subject, or any other organized method. In one embodiment, shipment tracking server program 130 selects emails to analyze by the date the email was received, starting with the most recently received email.

In step 220, shipment tracking server program 130 analyzes the selected email. In one embodiment, shipment tracking server program 130 performs text analytics on the selected email. Text analytics can be performed using an Unstructured Information Management Architecture (UIMA) application configured to analyze unstructured information to discover knowledge that is relevant to shipment tracking server program 130, by processing plain text and identifying entities, such as persons, places, merchants, couriers, other organizations; or relations, such as shipping-to or located-at. The performance of text analytics can also include applying annotators to text to produce annotations. Shipping information can include, for example, tracking numbers, tracking links, courier names, estimated delivery dates, or any other relevant piece of information.

To perform text analytics, shipment tracking server program 130 can parse the text of the email using a text parser and compare the text against information in analysis database 140. In one embodiment, shipment tracking server program 130 accesses analysis database 140 to retrieve the stored information for use when performing text analytics. Analysis database 140 can include definitions for words, synonyms for words, and rules for sentence construction and interpretation. For example, the text “Your order has shipped from Dallas, Tex. on Jan. 5, 2013. Track the status of your package at shippingcompany.com using tracking number 000-111-222-333.” Can be parsed into portions, including annotations, involving actions, times and dates, places, and participants. In particular, shipment tracking server program can determine an action in the text of the email, based on the text “has shipped” and also based on a rule that identifies particular verbs to indicate shipment delivery. Further, shipment tracking server program 130 can identify the location the delivery has shipped from, according to a rule that identifies the phrase “[shipped from] [location]” as one which specifies a location as being the location the delivery has shipped from. Similarly, the tracking number may be identified based on a rule that identifies “[tracking number] [set of characters]” as one which specifies a tracking number.

Shipment tracking server program 130 can identify a wide variety of information, based on analysis database 140, and is not limited to the above example. In addition to generally performing text analytics, analysis database 140 may contain multiple sets of dictionaries and rules for specific merchants and shipment service companies. Each set of dictionaries may provide specific terms used by, or to identify, the merchant or shipment service company in order to assist shipment tracking server program 130 in identifying where the delivery is coming from and what service is providing the delivery. Specific rules may exist to identify tracking numbers. For instance, a shipment service company may have rules for tracking number creation that require a certain number of letters, numbers, special characters, or total characters. Rules may be created to identify the shipment service company based on the tracking number identified.

In decision 230, shipment tracking server program 130 determines, using the information obtained by performing text analytics on the selected email (step 220), whether the selected email contains initial shipping information. In one embodiment, shipment tracking server program 130 uses natural language processing and at least one set of dictionaries and rules to perform text analytics on individual emails in an email account to determine if each individual email contains initial shipping information. For instance, initial shipping information might include the name of a courier, tracking information, or an estimated delivery date. Shipping information may include tracking numbers, links to tracking websites, estimated delivery dates, shipment service company names, merchant names, package details, or other relevant information. If shipment tracking server program 130 determines that the selected email does not contain initial shipping information (decision 230, no branch), then shipment tracking server program 130 determines if there are still more emails left to be analyzed (decision 260), and if so, returns to step 210 to repeat the process with the next email. Shipment tracking server program 130 determines that there are emails left to analyze by comparing the emails analyzed to the pool of all previously received emails (see step 200).

If shipment tracking server program 130 determines that the selected email contains initial shipping information (decision 230, yes branch), shipment tracking server program 130 extracts all relevant initial shipping information from the email using the text analytics techniques previously discussed (step 240). Extracted initial shipping information may include delivery address, recipient name, estimated delivery date and/or time, shipment date and/or time, parcel weight, parcel size, current location, tracking number, link to tracking website, and other relevant information. Shipment tracking server program 130 may store extracted initial shipping information to a file or database, such as email storage database 120 or analysis database 140.

In many instances, initial shipping information contained in the email will include tracking information. For example, as previously discussed, a tracking number or link to a tracking website may be provided. If tracking information is extracted from an email by shipment tracking server program 130 (during step 240), shipment tracking server program 130 proceeds to step 250. In step 250, shipment tracking server program 130 connects to a shipping company server, such as shipping company server 30 to obtain current shipping information (step 250). For example, if a tracking number is provided, shipment tracking server program 130 will use the tracking number to connect to shipping company server 30 and extract current shipping information. If no tracking information is extracted from the email by shipment tracking server program 130 (during step 240), then step 250 will be passed over.

In one embodiment, shipment tracking server program 130 may extract current shipping information from a shipping company server, such as shipping company server 30, via text analytic techniques previously discussed. In some instances, a tracking website or application may provide an application programming interface (API). An API is intended to be used as an interface by software components to communicate with each other. Many shipment service companies provide services with a corresponding API. If a tracking website uses an API, shipment tracking server program 130 may be able to call the API for specific current shipping information instead of relying on text analytic processes.

Shipment tracking server program 130 may use current shipping information obtained from a shipping company server, such as shipping company server 30, to replace or supplement initial shipping information previously extracted from one or more emails. For instance, estimated delivery date information obtained by shipment tracking server program 130 from shipping company server 30 may contain more recent information than was contained in the initial shipping information of the analyzed email, and shipment tracking server program 130 may use the current shipping information to overwrite previously obtained initial shipping information. Current shipping information obtained in step 250 may also be stored to a file or database, such as email storage database 120 or analysis database 140.

In decision 260, shipment tracking server program 130 determines whether or not there are additional emails to analyze. Shipment tracking server program 130 determines that there are emails left to analyze by comparing the emails analyzed to the pool of all previously received emails (see step 200). If there are more emails left to be analyzed (decision 260, yes branch), shipment tracking server program 130 selects the next email to be analyzed (step 210) from the pool of previously received emails (see step 200).

If there are no more emails left to analyze (decision 260, no branch), shipment tracking server program 130 consolidates all shipping information previously gathered and generates a shipment tracking report (step 270).

A shipment tracking report may compile all shipping information previously gathered and separate the information pieces into a table. Shipping information gathered may include tracking information, estimated delivery dates, package weight, package size, current location, associated email, courier, merchant, or any other relevant shipping information. Via text analytics processes previously performed, the relevant shipping information associated with each respective package may be placed into data fields corresponding to each piece of the shipping information gathered. In one embodiment, current shipping information gathered by shipment tracking server program 130 from a server, such as shipping company server 30, may replace or overwrite initial shipping information previously retrieved from email.

In one embodiment, shipment tracking server program 130 sends the generated shipment tracking report to shipment tracking client program 160. Shipment tracking client program 160 causes the shipment tracking report to be displayed on client computing device 50. In another embodiment, shipment tracking server program 130 consolidates all shipping information previously gathered, and sends the gathered shipping information to shipment tracking client program 160 to generate and display a shipment tracking report on client computing device 50.

In the present embodiment, shipment tracking client program 160 displays all shipping information gathered by shipment tracking server program 130 as a single report. FIG. 4 shows an example of a shipment tracking report. Exemplary embodiments will present the gathered shipping information as a report or list of orders that can be organized in different ways. For example, a user may be able to organize a report or list of orders by estimated delivery date, shipping company, or tracking number. All or some of the information gathered by shipment tracking server program 130 may be displayed on the report.

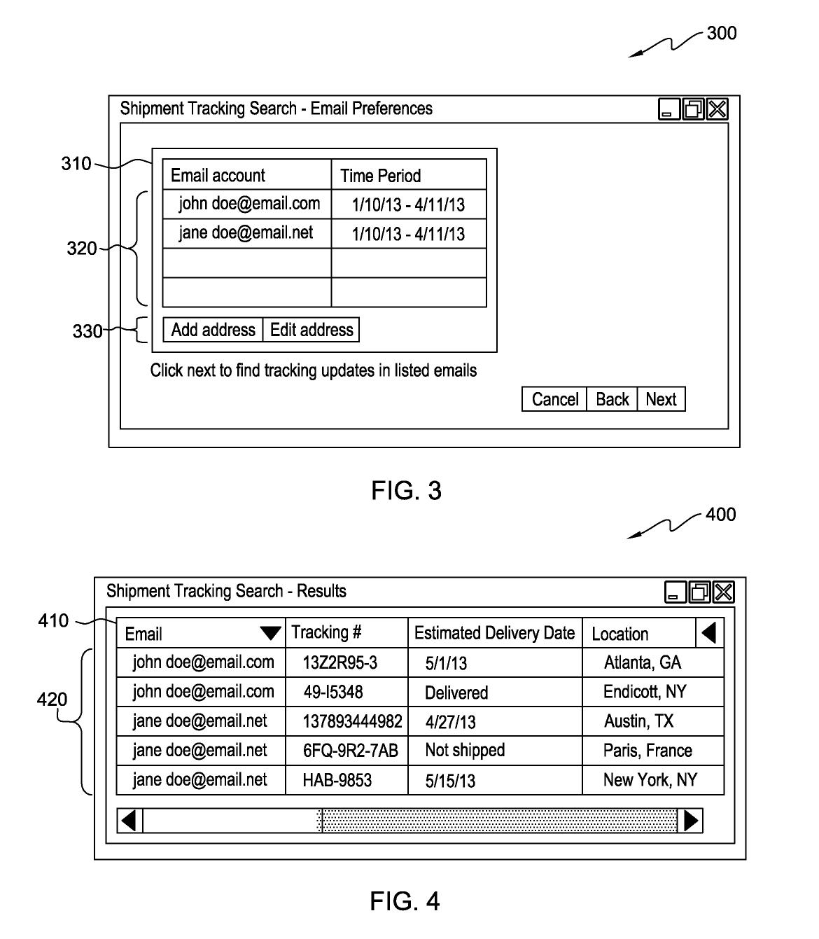

FIG. 3 is an exemplary user interface window to shipment tracking client program 160 in accordance with one embodiment of the present invention. User interface window 300 may be a user interface window to shipment tracking client program 160 of client computing device 50 of FIG. 1. User interface window 300 allows a user to request that shipment tracking server program 130 create a shipment tracking report. User interface window 300 also allows a user to select time periods to be searched (i.e., if an email was not received to the email account inbox within the listed time period, it will not be searched for initial shipping information by shipment tracking server program 130). In the depicted embodiment, user interface window 300 is shown as viewed by a user setting up a shipment tracking search.

User interface window 300 includes field headings 310, fields 320, and option buttons 330. User interface window 300 of the shipment tracking client program contains a number of field headings 310. Field headings 310 provide headings for the information that may be displayed in the fields below each field heading. In the current embodiment, field headings 310 include “email account” and “time period.” Fields 320 contain information corresponding to each field heading 310. In the current embodiment, fields 320 list the email accounts and time periods selected to be searched by shipment tracking server program 130. In other embodiments, additional field headings 310 and fields 320 may be provided. For instance, some additional headings may include password information or email account information. Option buttons 330 allow a user to add or edit email addresses to be searched by shipment tracking server program 130. Adding multiple email accounts allows for a more comprehensive and potentially more complete search and will allow for additional information to be included in a report.

In the depicted embodiment, two email accounts have been added: john_doe@email.com and jane_doe@email.net. For both email accounts, a time period of Jan. 10, 2013 to Apr. 11, 2013 has been selected. In one embodiment, a user would have the option to individually select time periods for each added email account.

When a user at client computing device 50 running shipment tracking client program 160 chooses to add or edit an email address using option buttons 330, shipment tracking client program 160 may request that the user enter information into a number of input fields. In order for shipment tracking server program 130 to access a newly added email account, shipment tracking client program 160 may require the input of specific account information such as the email address, server address, password, account type (e.g., POP3, IMAP, etc.), incoming mail server and outgoing mail server (SMTP) information. In some embodiments, optional information may also be added such as an account nickname or a set of preferences to restrict the emails to be searched by shipment tracking server program 130.

FIG. 4 is an exemplary shipment tracking report window displayed by shipment tracking client program 160, in accordance with one embodiment of the present invention. Exemplary shipment tracking report window 400 may be displayed after shipment tracking server program 130 has gathered and compiled shipping information from selected email accounts (see FIG. 3) and generated a report in accordance with one embodiment of the present invention.

Exemplary shipment tracking report window 400 contains a list of report headings 410 and report fields 420. In the depicted embodiment, the list of report headings 410 includes email, tracking number, estimated delivery date, and location. The list of report headings 410 may include other information such as shipment service company name, package weight, package description, merchant name, order date, ship date, or any other relevant information obtainable from either shipping company server 30 or a previously searched email. Report fields 420 contain the information obtained by shipment tracking server program 130 and the information is listed beneath each respective heading. When a heading from the list of report headings 410 is selected, the information in report fields 420 may be sorted accordingly. For instance, when the “Estimated Delivery Date” heading is selected, information will sort by date or status (i.e., items already shipped will be sorted as of their ship date, while items not yet shipped will be listed after all items with estimated delivery dates). When the information is sorted by headings not date relevant, the information may be sorted in alphabetical or numerical order.

Exemplary shipment tracking report window 400 contains the shipping information for deliveries associated with john_doe@email.com and jane_doe@email.net. Report fields 420 list each delivery along with all corresponding initial and current shipping information. In the depicted embodiment there are five deliveries with different tracking numbers, estimated delivery dates (or status updates such as “delivered” and “not shipped”), and each is currently in a different location. If a user were to horizontally scroll over, additional shipping information may be listed such as package weight, package dimensions, courier, merchant, etc.

Exemplary shipment tracking report window 400 is but one way to display the information obtained by shipment tracking server program 130. In another embodiment, shipment tracking server program 130 may be an integrated function to an email client program, such as email client program 150, and information obtained by shipment tracking server program 130 may be displayed on a tab within the email client program.

FIG. 5 depicts a block diagram of components of shipping company server 30, server computing device 40, and client computing device 50 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Shipping company server 30, server computing device 40, and client computing device 50 each include communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Email server program 110, email storage database 120, shipment tracking server program 130, and analysis database 140 are stored in persistent storage 508 of server computing device 40 for execution and/or access by one or more of the respective computer processors 504 of server computing device 40 via one or more memories of memory 506 of server computing device 40. Email client program 150 and shipment tracking client program 160 are stored in persistent storage 508 of client computing device 50 for execution by one or more of the respective computer processors 504 of client computing device 50 via one or more memories of memory 506 of client computing device 50. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Email server program 110, email storage database 120, shipment tracking server program 130, and analysis database 140 may be downloaded to persistent storage 508 of server computing device 40 through communications unit 510 of server computing device 40. Email client program 150 and shipment tracking client program 160 may be downloaded to persistent storage 508 of client computing device 50 through communications unit 510 of client computing device 50.

I/O interface(s) 512 allows for input and output of data with other devices that may be connected to computing system 10. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for compiling shipping information, the method comprising:
receiving one or more emails;
analyzing, by one or more processors, the one or more emails to determine tracking information for one or more shipments; and
determining, by the one or more processors, shipping information for each of the one or more shipments using the tracking information for each respective shipment.

2. The method of claim 1, wherein the step of analyzing, by the one or more processors, the one or more emails to determine tracking information for the one or more shipments includes performing text analytics on the text of the one or more emails.

3. The method of claim 2, wherein text analytics includes natural language processing with one or more set of dictionaries and rules.

4. The method of claim 1, wherein tracking information includes one or more tracking numbers.

5. The method of claim 1, wherein the step of determining, by one or more processors, shipping information for each of the one or more shipments using the tracking information for each respective shipment comprises:
requesting, using the tracking information for each respective shipment, the shipping information for each of the one or more shipments; and
receiving the shipping information for each of the one or more shipments.

6. The method of claim 1, further comprising:
analyzing the one or more emails to determine initial shipping information for the one or more shipments; and
generating, by the one or more processors, a shipment tracking report using the shipping information and the initial shipping information for each of the one or more shipments.

7. The method of claim 1, wherein the tracking information of the one or more emails includes one or more web links.

8. A computer program product for compiling shipping information, the computer program product comprising:
one or more computer-readable storage devices and program instructions stored on the one or more computer-readable storage devices, the program instructions comprising:
program instructions to receive one or more emails;
program instructions to analyze the one or more emails to determine tracking information for one or more shipments; and
program instructions to determine shipping information for each of the one or more shipments using the tracking information for each respective shipment.

9. The computer program product of claim 8, wherein program instructions to analyze the one or more emails to determine tracking information for the one or more shipments includes performing text analytics on the text of the one or more emails.

10. The computer program product of claim 9, wherein text analytics includes natural language processing with one or more set of dictionaries and rules.

11. The computer program product of claim 8, wherein the tracking information includes one or more tracking numbers.

12. The computer program product of claim 11, wherein program instructions to determine shipping information for each of the one or more shipments using the tracking information for each respective shipment includes:
program instructions to request, using the tracking information for each respective shipment, the shipping information for each of the one or more shipments; and
program instructions to receive the shipping information for each of the one or more shipments.

13. The computer program product of claim 8, further comprising:
program instructions, stored on the one or more computer-readable storage devices, to analyze the one or more emails to determine initial shipping information for the one or more shipments; and
program instructions, stored on the one or more computer-readable storage devices, to generate a shipment tracking report using the shipping information and the initial shipping information for each of the one or more shipments.

14. The computer program product of claim 8, wherein the tracking information of the one or more emails includes one or more web links.

15. A computer system for compiling shipping information, the computer system comprising:
one or more processors, one or more computer-readable memory devices, one or more computer-readable storage devices, and program instructions stored on the computer-readable storage devices for execution by at least one of the one or more processors via the one or more memory devices, the program instructions comprising:
program instructions to receive one or more emails;
program instructions to analyze the one or more emails to determine tracking information for one or more shipments; and
program instructions to determine shipping information for each of the one or more shipments using the tracking information for each respective shipment.

16. The computer system of claim 15, wherein program instructions to analyze the one or more emails to determine tracking information for the one or more shipments includes performing text analytics on the text of the one or more emails.

17. The computer system of claim 16, wherein text analytics includes natural language processing with one or more set of dictionaries and rules.

18. The computer system of claim 15, wherein the tracking information includes one or more tracking numbers.

19. The computer system of claim 18, wherein program instructions to determine shipping information for each of the one or more shipments using the tracking information for each respective shipment includes:
program instructions to request, using the tracking information for each respective shipment, the shipping information for each of the one or more shipments; and
program instructions to receive the shipping information for each of the one or more shipments.

20. The computer system of claim 15, further comprising:
program instructions, stored on the computer-readable storage devices for execution by at least one of the one or more processors via the one or more memory devices, to analyze one or more emails to determine initial shipping information for the one or more shipments; and
program instructions, stored on the computer-readable storage devices for execution by at least one of the one or more processors via the one or more memory devices, to generate a shipment tracking report using the shipping information and the initial shipping information for each of the one or more shipments.
